(19) United States
(12) Patent Application Publication
(10) Pub. No.: US 2010/0266827 A1
(43) Pub. Date: Oct. 21, 2010

(54) CARBON FIBER AND COMPOSITE MATERIAL USING THE SAME

(75) Inventors: Taro OYAMA, Sunto-gun (JP); Rie Kawahito, Sunto-gun (JP)

Correspondence Address: SUGHRUE MION, PLLC, 2100 PENNSYLVANIA AVENUE, N.W., SUITE 800, WASHINGTON, DC, 20037, US

(73) Assignee: TOHO TENAX CO., LTD., Tokyo (JP)

(21) Appl. No.: 12/427,406

(22) Filed: Apr. 21, 2009

(51) Int. Cl. B32B 5/16

(52) U.S. Cl. 428/219; 428/367

(57) ABSTRACT

The present invention relates to a carbon fiber having enhanced surface properties, tensile strength and tensile modulus to be able to obtain a composite material having high composite properties such as excellent impact resistance, preferably a carbon fiber of which tensile modulus is greater than or equal to 340 GPa and tensile strength is greater than or equal to 5970 MPa. The carbon fiber has the properties that the compression strength in the transverse direction of monofilament of the carbon fiber is greater than or equal to 130 kgf/mm², the surface oxygen concentration (O/C) of the carbon fiber is in the range of 20 to 30%, and the value of the specific surface area of the carbon fiber based on a BET method by krypton absorption is in the range of 0.65 to 2.5 m²/g. The present invention also relates to a composite material including the carbon fiber and a matrix resin wherein the compression strength after impact is preferably greater than or equal to 220 MPa.

### BACKGROUND OF THE INVENTION

1. Field of the Invention

The present invention relates to a carbon fiber having excellent surface properties which provide a composite material having an excellent impact resistance in the production of the composite material from a matrix resin and the carbon fiber, and the composite material thereof.

2. Description of the Related Art

In recent years, a composite material using a carbon fiber as the fiber reinforcement has been often used as a structural material of an airplane or the like owing to excellent mechanical properties such as lightness in weight or high strength. These composite materials are molded, for example, via a molding or processing process such as heating and pressing from a prepreg of the intermediate product in which the fiber reinforcement is impregnated with a matrix resin. Accordingly, the most suitable material and molding or processing process need to be adopted for each to obtain the desired composite material. Depending on the application, the carbon fiber of the fiber reinforcement also may be required to have a higher strength or the like. For example, as the tensile strength of the carbon fiber is kept, the tensile modulus needs to be enhanced for the purpose of the weight saving of the composite material for an airplane. However, typically, the brittleness of a carbon fiber increases and the impact resistance performance or the like thereof decreases as the tensile modulus thereof increases, and it is difficult to obtain the composite material having high composite properties.

It is essential to enhance the strength as well as the surface properties and the like of the carbon fiber itself for pursuing the high performance in producing the composite of the carbon fiber and a matrix resin. That is, it is to be able to obtain the composite material with higher properties (high strength, high modulus, high impact resistance or the like) by using the carbon fiber of which the surface and the matrix resin can adhere well to each other and dispersing more uniformly the matrix resin and the carbon fiber.

The enhancement of the tensile strength of the carbon fiber, as well as the enhancement of the surface properties, the improvement of the crystallizability of the surface and the like have been studied variously for a long time (See, for example, Patent document 1: Japanese Unexamined Patent Application Publication No. 5-214614; Patent document 2: Japanese Unexamined Patent Application Publication No. 10-25627; and Patent document 3: Japanese Unexamined Patent Application Publication No. 11-217734).

It is generally said that the relation between the surface condition of the carbon fiber and the strength of the composite material is strongly influenced by the adhesion to the matrix resin by the functional group on the surface of the carbon fiber and the anchor effect on the matrix resin by the irregularity on the surface of the carbon fiber. It is also said that if the surface of the carbon fiber is flat, the strength as composite material is not sufficiently developed owing to the low anchor effect on the matrix resin, and if the surface of the carbon fiber is highly irregular, the anchor effect on the matrix resin is large but the fiber defect formed by too large irregularity on the surface leads to the decrease of the strength of the composite material. For example, the relation between the irregularity of the surface of the carbon fiber measured using a scanning probe microscope and the strength of the carbon fiber and the composite material has been studied, and the improving measure thereof also has been suggested (See, for example, Patent document 4: Japanese Unexamined Patent Application Publication No. 2003-73932; Patent document 5: Japanese Unexamined Patent Application Publication No. 2005-133274; and Patent document 6: Japanese Unexamined Patent Application Publication No. 2004-277192). However, the conventional carbon fibers do not have the sufficient properties yet to obtain the composite material having the high composite properties for primary structural material for an airplane or the like.

### SUMMARY OF THE INVENTION

It is an object of the present invention to provide a carbon fiber having the enhanced surface properties, strength to be able to obtain a composite material having the high composite properties such as more excellent impact resistance than the conventional composite materials.

The present inventors tried to provide the surface of the carbon fiber with a structure absorbing impact, enhance the impact resistance of the carbon fiber itself and control the adhesion to the matrix resin to obtain the composite material having the enhanced impact resistance, the high composite properties and particularly the excellent compression strength after impact (CAI). Then, the present invention has been achieved by finding that the brittleness can be improved for the enhancement of the CAI by controlling the transverse compressive strength of monofilament of the carbon fiber to a suitable value, the CAI of the composite material is enhanced by adjusting the surface oxygen concentration (O/C) and the value of the specific surface area in relation to the adhesion to the matrix resin to a suitable value, and the like.

The present invention is described below in items (1)-(5).

(1) The invention described in item (1) is a carbon fiber wherein the compression strength in the transverse direction of monofilament of the carbon fiber is greater than or equal to 130 kgf/mm², the surface oxygen concentration (O/C) of the carbon fiber is in the range of 20 to 30%, and the value of the specific surface area of the carbon fiber based on the BET method by krypton absorption is in the range of 0.65 to 2.5 m²/g.

(2) The invention described in item (2) is the carbon fiber of item (1), wherein the tensile modulus of the carbon fiber is greater than or equal to 340 GPa and the tensile strength of the carbon fiber is greater than or equal to 5970 MPa.

(3) The invention described in item (3) is a composite material including a matrix resin and a carbon fiber wherein the compression strength in the transverse direction of monofilament of the carbon fiber is greater than or equal to 130 kgf/mm², the surface oxygen concentration (O/C) of the carbon fiber is in the range of 20 to 30%, and the value of the specific surface area of the carbon fiber based on a BET method by krypton absorption is in the range of 0.65 to 2.5 m²/g.

(4) The invention described in item (4) is the composite material of item (3), wherein the tensile modulus of the carbon fiber is greater than or equal to 340 GPa and the tensile strength of the carbon fiber is greater than or equal to 5970 MPa.

(5) The invention described in item (5) is the composite material of items (3) or (4), wherein the compression strength after impact (CAI) of the composite material is greater than or equal to 220 MPa.

The carbon fiber of the present invention has a high tensile strength and a high tensile modulus as the compressive strength in the transverse direction of monofilament is high and the surface oxygen concentration (O/C) of the surface of the fiber and the value of the specific surface area based on a BET method by krypton absorption are in the suitable region. The carbon fiber of the present invention functions as a reinforcing material having the good adhesion to the matrix resin, and the obtained composite material has the excellent composite properties and particularly the excellent CAI. Thus, the higher performance composite material than a conventional composite material can be obtained using the carbon fiber of the present invention, and these can be utilized as a safe and light composite material in the fields such as aeroplane and aerospace or automobile.

### DETAILED DESCRIPTION OF THE PREFERRED EMBODIMENTS

The present invention is a carbon fiber wherein the compression strength in the transverse direction of monofilament is greater than or equal to 130 kgf/mm², preferably greater than or equal to 135 kgf/mm², the surface oxygen concentration (O/C) is in the range of 20 to 30%, preferably 25 to 29%, and the value of the specific surface area based on the BET method by krypton absorption is in the range of 0.65 to 2.5 m²/g, preferably 1.3 to 2.4 m²/g. More preferably, the tensile modulus is greater than or equal to 340 GPa and the tensile strength is greater than or equal to 5970 MPa.

The carbon-fiber-reinforced composite material having a high CAI, e.g. 230 to 250 MPa, has been conventionally obtained using a carbon fiber having a medium strength, e.g. 5680 MPa, and a medium tensile modulus, e.g. less or equal 294 GPa. While the development of the carbon fiber satisfying both of a high strength and a high tensile modulus is being conducted to meet a specification of a more high performance composite material for the main purpose of weight saving of a structural material in the field of airplanes, the elongation of the carbon fiber is decreased as the tensile modulus is increased, so the CAI of the obtained composite material is disadvantageously decreased.

In the present invention, the impact resistance of the fiber itself is enhanced by removing the part of the break starting point of the carbon fiber and providing the surface with the structure absorbing impact, as well as the delamination is inhibited and the failure of the composite material is ingeniously prevented owing to the brittleness of the carbon fiber enhancing the adhesion between the fiber and the matrix resin by controlling the surface condition of the carbon fiber.

In the present invention, the compressive strength in the transverse direction of monofilament refers to the compressive strength in the perpendicular direction against the fiber direction of the monofilament of the carbon fiber. The compression strength is greater than or equal to 130 kgf/mm², preferably greater then or equal to 135 kgf/mm. The measuring method will be described in connection with the Examples below.

The surface oxygen concentration in the present invention means the O/C value of the carbon fiber measured with an X-ray photoelectron spectrometer, and the O/C value needs to be in the range of 20 to 30%, more preferably 25 to 29%. If the O/C value is less than 20%, the adhesion between the carbon fiber and the matrix resin is inferior to the carbon fiber having a suitable O/C and it causes the decline of the properties of the obtained composite material. The O/C value of more than 30% is unsuitable since the strength of the carbon fiber itself decreases by an excess of oxidation treatment and the adhesion to the matrix resin is too strong, and then the impact cannot be absorbed in the interface in forming the composite and the impact resistance tends to be inferior.

The value of the specific surface area based on a BET method by krypton absorption in the present invention refers to the value representing the surface condition of the carbon material. The value of the monolayer adsorption volume in the adsorption of gas molecules of which the occupied area by adsorption is known to a sample is used and is calculated by the following expression:

S=([Vm×N×Acs]M)/w
S: Specific surface area
Vm: Monolayer adsorption volume
N: Avogadro constant
Acs: Adsorption cross section
M: Molecular weight
w: Sample weight

The value of the specific surface area of the carbon fiber in the present invention needs to be in the range of 0.65 to 2.5 m²/g, preferably in the range of 1.3 to 2.4 m²/g. This value is an indicator of the degree of etching effect by the surface treatment of the carbon fiber surface. The surface area and irregularity of the carbon fiber increase as the value of the indicator increases.

The surface of the carbon fiber is treated, for example, with etching by electrolytic oxidation, and the brittle site which forms a surface defect of the carbon fiber and has produced in a burning process is selectively removed by etching to enhance the strength of the carbon fiber itself. The surface area of the carbon fiber is spread owing to the production of fine irregularity on the surface of the fiber as the brittle site is removed, and the sufficient contact between the carbon fiber and the matrix resin can be obtained. Furthermore, a functional group such as a carboxyl group or a hydroxyl group having an effect enhancing the affinity for the matrix resin is introduced. As a result, the adhesion between the carbon fiber and the matrix resin is enhanced owing to the anchor effect, and the impact resistance or the like of the obtained composite material is presumed to be enhanced.

The degree of the surface treatment, for example in etching by electrolytic oxidation, depends on an electric quantity for use, and the higher the electric quantity is, the more strongly the surface of the fiber is etched. Conversely, if an excess of the treatment is performed, the excessively etched site undesirably forms a new defect. The physical defect (the structural site having high crystallizability and low orientation) such as a crack or a void formed at this time forms the new break starting point of the carbon fiber. Thus, moderate etching is needed for forming the optimized surface condition.

The carbon fiber of the present invention can be produced, for example, by the following method.

### [Precursor Fiber]

The heretofore known precursor fiber such as a pitchy fiber or an acrylic fiber can be used without any limitation as the precursor fiber used in the production method of the carbon fiber in the present invention. The acrylic fiber is preferable among them, and the acrylic fiber having the orientation of up to 90.5% measured by wide-angle X-ray diffraction (the diffraction angle is 17°) is more preferable. Concretely, a fiber spinning solution obtained polymerizing a monomer containing acrylonitrile of greater than or equal to 90% by mass, preferably greater than or equal to 95% by mass, is spun to produce a carbon fiber raw material (precursor fiber) Either a wet fiber spinning method or a dry fiber spinning method can be used as the fiber spinning method, and the wet fiber spinning method is preferable in consideration of the adhesion to resin. The carbon fiber raw material is preferably water-washed, dried and drawn after solidification.

### [Preoxidation Treatment]

The preoxidation treatment for the obtained precursor fiber is subsequently performed in heated air at a temperature in the range of 200 to 280° C., preferably 240 to 250° C. The treatment at this time is typically performed in a draw ratio in the range of 0.85 to 1.30, more preferably greater than or equal to 0.95 for obtaining the carbon fiber having a high strength and a high elastic coefficient. In this preoxidation treatment, the oxidized fiber of which fiber density is 1.3 to 1.5 g/cm³ is formed, and the tension to the fiber in the preoxidation treatment is not especially limited.

### [First Carbonization Treatment]

In a first carbonization process, a first carbonization treatment fiber having the fiber density of 1.40 to 1.70 g/cm³ is obtained from the oxidized fiber described above in an inactive gas atmosphere at a temperature in the range of 300 to 900° C., preferably 300 to 550° C., by a first drawing in the draw ratio of 1.03 to 1.06 and then a second drawing in the draw ratio of 0.9 to 1.01. In the first drawing of the first carbonization process, the drawing is preferably performed in the draw ratio of 1.03 to 1.06 while the tensile modulus of the oxidized fiber increases to 9.8 GPa from the point that the tensile modulus decreases to the minimum value and the density of the fiber reaches 1.5 g/cm³. In the second drawing, the drawing is preferably performed in the draw ratio of 0.9 to 1.01 while the density of the fiber after the first drawing keeps on increasing in the second drawing. By adopting this condition, the crystal comes dense without growing, the formation of a void can be inhibited, and the high tensile strength carbon fiber having high denseness can be ultimately obtained. The first carbonization process described above can be continuously or separately performed in one or more furnaces.

### [Second Carbonization Treatment]

In a second carbonization process, a second carbonization treatment fiber is obtained in an inactive gas atmosphere at a temperature in the range of 800 to 2100° C., preferably 1000 to 1450° C., conducting a drawing of the first carbonization treatment fiber described above, in parts, in a first treatment and a second treatment. In the first treatment, the drawing of the first carbonization treatment fiber is preferably performed while the density of the first carbonization treatment fiber keeps on increasing in the first treatment and the nitrogen content in the first carbonization treatment fiber is greater than or equal to 10% by mass. In the second treatment, the drawing of the first treatment fiber is preferably performed while the density of the first treatment fiber is steady or decreases. The elongation of the second carbonization treatment fiber is greater than or equal to 2.0%, more preferably greater than or equal to 2.2%, and the diameter of the second carbonization treatment fiber is preferably 5 to 6.5 μm. These carbonization processes can be continuously performed in a single or several pieces of equipment, and it is not especially limited.

### [Third Carbonization Treatment]

In a third carbonization process, the second carbonization treatment fiber described above is further carbonized or graphitized at 1500 to 2100° C., preferably 1650 to 1900° C.

### [Surface Treatment]

A surface treatment of the third carbonization treatment fiber described above is subsequently conducted. The treatment in a gas or liquid phase can be used for the surface treatment, and the surface treatment by an electrolysis treatment is preferable with respect to the convenience of the process management and the enhancement of the productivity. An inorganic acid, inorganic acid salt or the like, preferably an inorganic acid such as sulfuric acid, nitric acid or hydrochloric acid can be used as the electrolyte used in the surface treatment. The chemical and electric oxidation treatment is advantageously performed with the concentration of these electrolytes being 1 to 25% by mass, the temperature being in the range of 10 to 80° C., more preferably 20 to 50° C., and the electric quantity per 1 g of the fiber being 10 to 2000 coulombs, more preferably 100 to 500 coulombs. The etching amount increases and the removal of the brittle site is improved by increasing the electric quantity. However, if the electric quantity is too large, defects on the surface are undesirably formed owing to an excess of etching to decrease the strength of the fiber. If the electric quantity is too small, undesirably the brittle site is insufficiently removed to decrease the strength of the fiber.

Using nitric acid as the electrolyte, the more efficient etching can be preferably performed since nitric acid enters between the layers of the graphite structure of the carbon fiber and reacts. In this case, it is assumed that a gap which occurs along the portion with large crystallites and low electric resistance is produced between the layers by an electrolytic oxidation reaction between the layers of the graphite structure. The surface of carbon fiber is covered with an electric double layer by electrolytic treatment, and the value of electric resistance of the interface increases. For these reasons, it is assumed that only the very surface part is electrolyzed with a small electric quantity.

### [Sizing Treatment]

A sizing treatment of the surface treatment fiber described above is subsequently conducted. The sizing method can be performed by a heretofore known method. The sizing agent is preferably used suitably altering the composition in response to the application to be uniformly attached and then dried.

Another aspect of the present invention is a composite material obtained from a matrix resin and a carbon fiber wherein the carbon fiber of the present invention obtained as described above is used as the fiber reinforcement. The carbon fiber is used, wherein the compression strength in the transverse direction of monofilament is greater than or equal to 130 kgf/mm², the surface oxygen concentration (O/C) is in the range of 20 to 30% and the value of the specific surface area based on a BET method by krypton absorption is in the range of 0.65 to 2.5 m²/g. The carbon fiber is more preferably used, wherein the tensile modulus is greater than or equal to 340 GPa and the tensile strength is greater than or equal to 5970 MPa. For example, the composite material in the present invention means a prepreg, a preform, a molding or the like produced from the carbon fiber and various matrix resins by a various heretofore known method such as a hot melt method or a filament winding method.

A carbon fiber is normally used in sheet-shaped fiber reinforced material. The sheet-shaped material includes all of one in which the fiber material is arranged in one direction in a sheet shape, one in which these are laminated, for example, orthogonally, one formed from the fiber material into cloth such as fabric or nonwoven fabric, strand-shaped one and multiaxial fabric. Long-fiber-shaped monofilament or a bundle thereof is preferably used as the shape of the fiber.

The matrix resin used in the present invention is not especially limited. Specific examples of a thermosetting matrix resin can include epoxy resin, unsaturated polyester resin, phenol resin, vinyl ester resin, cyanic acid ester resin, urethane acrylate resin, phenoxy resin, alkyd resin, urethane resin, prepolymerization resin of maleimide resin and cyanic acid ester resin, bismaleimide resin, acetylene-terminated polyimide or polyisoimide resin, and nadic acid-terminated polyimide resin. These can be also used as one or more mixture. Among them, epoxy resin and vinyl ester resin having excellent heat resistance, tensile modulus and chemical resistance are particularly preferable. These thermosetting resins may contain a curing agent and a curing accelerator, as well as a colorant, various additives and the like normally used.

The thermoplastic resin used as matrix resin includes, for example, polypropylene, polysulfone, polyether sulfone, polyether ketone, polyether ether ketone, aromatic polyamide, aromatic polyester, aromatic polycarbonate, polyether imide, polyarylene oxide, thermoplastic polyimide, polyamide, polyamide imide, polyacetal, polyphenylene oxide, polyphenylene sulfide, polyallylate, polyacrylonitrile, polyaramide or polybenzimidazole.

The content of the resin composition in the composite material is 10 to 90% by weight, preferably 20 to 60% by weight, further preferably 25 to 45% by weight. The preferable composite material has greater than or equal to 220 MPa of CAI measured by a method described in detail in the Examples.

### EXAMPLES

The present invention will be described in detail, but will not be limited, by the Examples as follows. The measuring methods of the values of various properties in the Examples will be described below.

The compression strength in the transverse direction of monofilament means a compression strength in the perpendicular direction against the direction of the fiber of the monofilament of the carbon fiber (measured with n=5). The sample in which the yarn of the carbon fiber was fixed on a slide glass was made prior to the measurement and was measured at the loading rate of 7.25 mgf/sec by using the micro compression tester “MCTM-200” produced by SHIMADZU CORPORATION and the 50 μm planar indenter.

The surface oxygen concentration (O/C) of the carbon fiber can be calculated by XPS (ESCA) according to a procedure described below. After the carbon fiber is cut and arranged scattering on a stainless-steel sample supporter, the inside of the sample chamber is kept to a degree of vacuum of 1×10⁻⁶ Pa with a photoelectron escape angle set at 90° and MgKα used as an X-ray source. At first, the value of the bond energy B.E. of the main peak of C1s is adjusted to 284.6 eV for the peak correction associated with a charging in the measurement. The peak area of O1s is calculated by drawing a linear base line in the range of 528 to 540 eV, and the peak area of C1s is calculated by drawing a linear base line in the range of 282 to 292 eV. The surface oxygen concentration O/C of the surface of the carbon fiber is calculated from a ratio of the peak area of O1s to the peak area of C1s described above.

The specific surface area of the carbon fiber based on a BET method by krypton gas absorption is calculated using the carbon fiber cut in approximately 1 m long and analyzing a BET plot in the relative pressure range of approximately 0.1 to 0.25 according to the BET theory. The gas adsorption was performed at the condition described below using the automatic gas adsorption equipment “AUTOSORB-1” produced by YUASA-IONICS COMPANY, LIMITED.
Adsorbed gas: Kr
Dead volume: He
Adsorption temperature: 77 K (liquid nitrogen temperature)
Measurement range: Relative pressure (P/P₀)=0.05−0.3
P: Measurement pressure, P₀: Saturated vapor pressure of Kr

The impact resistance was evaluated by measuring the compression strength after impact (CAI) in conformity to a SACMA method. For the CAI measurement, the unidirectional prepreg having a carbon fiber area density of 270 g/m² and a resin content of 33% was produced using the carbon fiber after sizing and the epoxy resin (No.133) produced by Toho Tenax to perform a quasi-isotropic lamination in [+45°/0°/−45°/90°]_{4S}. The laminated specimen (sample) was cured at 180° C. for 2 hours, and then the specimen (sample) of 100×150×4.2 mm was produced.

The specimen (sample) was subjected to an impact energy of 30 J using the drop weight impact tester (GRC-8250 produced by Dynatup) as an impact test after the dimensional measurement of each specimen. The damaged area of the specimen after the impact was measured with the ultrasonic crack tester (M610 produced by Canon). The strength test of the specimen after the impact was performed by loading to the break of specimen with the crosshead speed of the test machine (Auto Graph AG-100TB produced by SHIMADZU CORPORATION) being 1.3 mm/min after a pair of strain gauges had been fixed each on the right and left side at the position of 25.4 mm from the top of the specimen and 25.4 mm from the side of the specimen and a total of four gauges per specimen had been fixed in turn on the front and back side.

The resin-impregnated strand tensile strength and tensile modulus of the carbon fiber was measured by a method defined in JIS R 7601. The removal of the sizing agent of the carbon fiber was performed by a Soxhlet treatment using acetone for 3 hours, and then the fiber was air-dried. The density was measured by an Archimedes method after the sample fiber had been degassed in acetone.

### Example 1

The wet fiber spinning of the fiber spinning copolymer raw liquid composed of 95% by mass of acrylonitrile/4% by mass of methyl acrylate/1% by mass of itaconic acid was performed by a conventional method. Then a steam drawing was performed so that a total draw ratio was 14 times to obtain a precursor fiber having 12000 filaments and a fineness of 0.65 denier after water-washing, oiling and drying.

While the obtained precursor fiber was drawn in heated air, the preoxidation treatment was performed at a temperature in the range of 240 to 250° C. Then the first, second and third carbonization treatments were performed in a nitrogen atmosphere at a temperature in the range of 300 to 2000° C. to obtain an unelectrolyzed carbon fiber.

The unelectrolyzed carbon fiber described above was electrolyzed using 6.3% by mass of an aqueous solution of nitric acid as an electrolyte solution in 4 tubs in the condition of the electric quantity of 450 coulombs/g. Then the polarities were changed and the fiber was electrolyzed in 2 tubs in the condition of the electric quantity of 15 coulombs/g. The sizing treatment of the electrolyzed carbon fiber was performed by a conventional method to obtain the 0.31 denier carbon fiber having a density of 1.77 g/cm³ drying. The measuring value of the tensile strength (resin-impregnated strand strength), tensile modulus, monofilament compression strength, surface oxygen concentration O/C, value of the specific surface area and CAI of the obtained carbon fiber are shown in Table 1.

### Example 2

The unelectrolyzed carbon fiber obtained in Example 1 was electrolyzed using 6.3% by mass of an aqueous solution of nitric acid in 4 tubs in the condition of the electric quantity of 290 coulombs/g. Then the polarities were changed and the fiber was electrolyzed in 2 tubs in the condition of the electric quantity of 25 coulombs/g. The sizing treatment of the electrolyzed carbon fiber was performed by a conventional method to obtain the 0.31 deniers carbon fiber having a density of 1.77 g/cm³ drying. The measuring value of the tensile strength, tensile modulus, monofilament compression strength, surface oxygen concentration O/C, value of the specific surface area and CAI of the obtained carbon fiber are shown in Table 1.

### Example 3

The unelectrolyzed carbon fiber obtained in Example 1 was electrolyzed using 6.3% by mass of an aqueous solution of nitric acid in 12 tubs in the condition of the electric quantity of 100 coulombs/g. Then the sizing treatment was performed by a conventional method to obtain the 0.31 denier carbon fiber having a density of 1.77 g/cm³ drying. The measuring value of the tensile strength, tensile modulus, monofilament compression strength, surface oxygen concentration O/C, value of the specific surface area and CAI of the obtained carbon fiber are shown in Table 1.

### Comparative Example 1

The unelectrolyzed carbon fiber obtained in Example 1 was electrolyzed using 6.3% by mass of an aqueous solution of nitric acid in 12 tubs in the condition of a total of the electric quantity of 50 coulombs/g. Then the sizing treatment was performed by a conventional method to obtain the 0.31 deniers carbon fiber having a density of 1.77 g/cm³ drying. The measuring value of the tensile strength, tensile modulus monofilament compression strength, surface oxygen concentration O/C, value of the specific surface area and CAI of the obtained carbon fiber are shown in Table 1.

### Comparative Example 2

The unelectrolyzed carbon fiber obtained in Example 1 was electrolyzed using 6.3% by mass of an aqueous solution of nitric acid in 12 tubs in the condition of a total of the electric quantity of 250 coulombs/g. Then the sizing treatment of was performed by a conventional method to obtain the 0.31 denier carbon fiber having a density of 1.77 g/cm³ drying. The measuring value of the tensile strength, tensile modulus, monofilament compression strength, surface oxygen concentration O/C, value of the specific surface area and CAI of the obtained carbon fiber are shown in Table 1.

### Comparative Example 3

The unelectrolyzed carbon fiber obtained in Example 1 was electrolyzed using 6.3% by mass of an aqueous solution of nitric acid in 3 tubs in the condition of a total of the electric quantity of 250 coulombs/g. Then the sizing treatment was performed by a conventional method to obtain the 0.31 denier carbon fiber having a density of 1.77 g/cm³ drying. The measuring value of the tensile strength, tensile modulus, monofilament compression strength, surface oxygen concentration O/C, value of the specific surface area and CAI of the obtained carbon fiber are shown in Table 1.

### Comparative Example 4

The unelectrolyzed carbon fiber obtained in Example 1 was electrolyzed using 6.3% by mass of an aqueous solution of nitric acid in 4 tubs in the condition of a total of the electric quantity of 250 coulombs/g. Then the sizing treatment was performed by a conventional method to obtain the 0.31 denier carbon fiber having a density of 1.77 g/cm³ drying. The measuring value of the tensile strength, tensile modulus, monofilament compression strength, surface oxygen concentration O/C, value of the specific surface area and CAI of the obtained carbon fiber are shown in Table 1.

### Comparative Example 5

The unelectrolyzed carbon fiber obtained in Example 1 was not electrolyzed, and the sizing treatment was performed by a conventional method to obtain the 0.31 denier carbon fiber having a density of 1.77 g/cm³ drying. The measuring value of the tensile strength, tensile modulus, monofilament compression strength, surface oxygen concentration O/C, value of the specific surface area and CAI of the obtained carbon fiber are shown in Table 1.

### Comparative Example 6

The unelectrolyzed carbon fiber obtained in Example 1 was electrolyzed using 10.0% by mass of an aqueous solution of ammonium sulfate in 3 tubs in the condition of a total of the electric quantity of 80 coulombs/g. Then the sizing treatment was performed by a conventional method to obtain the 0.31 denier carbon fiber having a density of 1.77 g/cm³ drying. The measuring value of the tensile strength, tensile modulus, monofilament compression strength, surface oxygen concentration O/C, value of the specific surface area and CAI of the obtained carbon fiber are shown in Table 1.

TABLE 1

| | Monofilament | | Specific | | | |
|---|---|---|---|---|---|---|
| | compression | | surface | Tensile | Tensile | |
| | strength | Value of O/C | area | strength | modulus | CAI |
| | (kgf/mm²) | (%) | (m²/g) | (MPa) | (GPa) | (MPa) |
| Example 1 | 138 | 28.5 | 1.33 | 6076 | 353 | 234 |
| Example 2 | 139 | 26.5 | 2.28 | 6076 | 342 | 234 |
| Example 3 | 132 | 26.2 | 0.65 | 5978 | 343 | 223 |
| Comparative | 122 | 15.0 | 0.59 | 5880 | 343 | 170 |
| example 1 | | | | | | |
| Comparative | 120 | 35.7 | 0.60 | 5801 | 343 | 206 |
| example 2 | | | | | | |
| Comparative | 134 | 14.0 | 1.30 | 6174 | 343 | 171 |
| example 3 | | | | | | |
| Comparative | 138 | 28.0 | 2.52 | 6056 | 352 | 218 |
| example 4 | | | | | | |
| Comparative | 120 | 3.1 | 0.54 | 5782 | 348 | 150 |
| example 5 | | | | | | |
| Comparative | 128 | 14.2 | 0.64 | 5831 | 348 | 181 |
| example 6 | | | | | | |

What is claimed is:

1. A carbon fiber wherein the compression strength in the transverse direction of monofilament of the carbon fiber is greater than or equal to 130 kgf/mm², the surface oxygen concentration (O/C) of the carbon fiber is in the range of 20 to 30%, and the value of the specific surface area of the carbon fiber based on a BET method by krypton absorption is in the range of 0.65 to 2.5 m²/g.

2. The carbon fiber of claim 1, wherein
the tensile modulus of the carbon fiber is greater than or equal to 340 GPa and the tensile strength of the carbon fiber is greater than or equal to 5970 MPa.

3. A composite material comprising a matrix resin and a carbon fiber wherein the compression strength in the transverse direction of monofilament of the carbon fiber is greater than or equal to 130 kgf/mm², the surface oxygen concentration (O/C) of the carbon fiber is in the range of 20 to 30%, and the value of the specific surface area of the carbon fiber based on a BET method by krypton absorption is in the range of 0.65 to 2.5 m²/g.

4. The composite material of claim 3, wherein
the tensile modulus of the carbon fiber is greater than or equal to 340 GPa and the tensile strength of the carbon fiber is greater than or equal to 5970 MPa.

5. The composite material of claim 3, wherein
the compression strength after impact (CAI) of the composite material is greater than or equal to 220 MPa.

6. The composite material of claim 4, wherein
the compression strength after impact (CAI) of the composite material is greater than or equal to 220 MPa.
